(19) United States
(12) Patent Application Publication
(10) Pub. No.: US 2008/0170701 A1
(43) Pub. Date: Jul. 17, 2008

(54) Delegation system for decryption rights

(75) Inventors: Toshihiko Matsuo, Tokyo (JP); Dan Boneh, Palo Alto, CA (US); Eu-Jin Goh, Palo Alto, CA (US)

Correspondence Address: THELEN REID BROWN RAYSMAN & STEINER LLP, P. O. BOX 640640, SAN JOSE, CA, 95164-0640, US

(73) Assignees: NTT DATA CORPORATION, TOKYO (JP); The Board of Trustees of the Leland Stanford Junior University, Palo Alto, CA (US)

(21) Appl. No.: 11/894,448

(22) Filed: Aug. 21, 2007

Related U.S. Application Data
(60) Provisional application No. 60/839,516, filed on Aug. 22, 2006.

(51) Int. Cl. H04L 9/08; H04L 9/30; H04L 9/14

(52) U.S. Cl. 380/281; 380/45; 380/30

(57) ABSTRACT

An object of this ciphertext decryption rights delegation system is to enable conversion of PKE-system ciphertext into IBE-system encrypted ciphertext, and, in a delegation system with users using only an IBE system, of preventing restoration of the master-secret key generated by a PKG device (public key generation device) even when there is collusion attack between the ciphertext converter and a decryption rights delegatee. A ciphertext decryption rights delegation system realizes delegation of ciphertext decryption rights between a device used by a decryption rights delegator and a device used by a decryption rights delegatee. From the master-secret key stored in the PKG device which generates secret keys, a secret key of the IBE system and auxiliary information are generated, and a re-encryption key is generated based on this auxiliary information. When sharing content, ciphertext encrypted by the decryption rights delegator device is converted by a ciphertext conversion device using the re-encryption key, and the converted ciphertext is decoded by the decryption rights delegatee device using the IBE-system secret key.

### CROSS-REFERENCE TO RELATED PATENT APPLICATION OR PRIORITY CLAIM

This application claims priority on U.S. Provisional Patent Application No. 60/839,516, filed Aug. 22, 2006, the content of which incorporated herein by reference.

### BACKGROUND OF THE INVENTION

1. Field of the Invention

This invention relates to a delegation system for decryption rights, enabling decryption of ciphertext, generated using a certain public key, using a secret key different from the secret key corresponding to the public key.

Priority is claimed on U.S. Provisional Patent Application No. 60/839,516, filed Aug. 22, 2006, the content of which is incorporated herein by reference.

2. Description of the Related Art

In encryption using public key encryption, only persons having a corresponding secret key have been capable of decryption of ciphertext which has been encrypted using a certain public key. Due to the usefulness of such systems, in recent years research has been conducted on delegation systems for ciphertext decryption rights (hereafter simply “delegation systems”), enabling decryption of ciphertext, encrypted using a certain public key, using a secret key which differs from the secret key corresponding to the public key. A delegation system comprises three persons, which are a delegator, a delegatee, and a ciphertext converter, or else four persons, with the addition to these of a trusted third party (hereafter “TTP”). Decryption right delegation in such a system entails generation of a re-encryption key for ciphertext conversion by the delegator or TTP, and transfer of the re-encryption key to the ciphertext converter. When plaintext possessed by the delegator is held in common with the delegatee, first the ciphertext obtained by encryption of the plaintext by the delegator using his own public key is transmitted to the ciphertext converter. The ciphertext converter, who holds the re-encryption key, converts the ciphertext received from the delegator such that decryption is possible using the secret key held by the delegatee, and the ciphertext is transmitted to the delegatee. The delegatee uses his own secret key to decrypt the received ciphertext which has been converted, to reproduce the plaintext. Such a delegation system is required to satisfy the following three conditions from a cryptographic standpoint. That is, (1) there must be no need for the delegatee to transfer his own decryption secret key to another person; (2) so long as the ciphertext converter does not perform conversion, the delegatee cannot reproduce the plaintext; and, (3) the ciphertext converter cannot independently reproduce the plaintext from the ciphertext of the delegator.

As devices to realize delegation, used by the delegator and delegatee (and hereafter respectively called the “decryption rights delegator device” and “decryption rights delegates device”), a computer, such as for example a personal computer, portable phone terminal, PDA (Personal Digital Assistant), server, or similar is employed; and as the device used by the ciphertext converter (hereafter “ciphertext conversion device”), a device comprising a server or similar called a proxy is employed. Computers which serve as decryption rights delegator devices or decryption rights delegatee devices comprise functions to execute public key encryption algorithms, and store a public key necessary for encryption and a secret key necessary for decryption. The proxy serving as the ciphertext conversion device is provided with functions to execute a conversion algorithm to convert ciphertext transmitted from the device of the delegator, and stores a re-encryption key.

Such a delegation system can for example be applied to content provision technology through storage equipment used by an unspecified number of users. Suppose that a delegator is the owner of certain content, and that content encrypted using his own public key is stored by storage equipment used by an unspecified number of users. When content is shared with a third party, the delegator chooses the third party as a delegatee, generates a re-encryption key for the delegatee, and transmits the re-encryption key to the ciphertext conversion device which is an access controller for the storage equipment. The ciphertext conversion device, upon receiving a request for content from the decryption rights delegates device of the delegatee, uses the re-encryption key to re-encrypt the ciphertext of the content, and transmits the converted ciphertext to the decryption rights delegatee device. The decryption rights delegatee device uses a delegatee secret key stored internally to decrypt the content. The ciphertext conversion device cannot independently decrypt the content; and because the content is stored in an encrypted state in the storage equipment of the ciphertext conversion device, the delegator and delegatee can securely share the content. Further, in the event of content sharing, there is no need for additional calculations by the delegator, so that efficient sharing is possible.

One public encryption system used to realize a rights delegation system is the standard Public Key Encryption (hereafter “PKE”) system, which uses a random number as a public key, and an Identity Based Encryption (hereafter “IBE”) system, as described in Reference 1 ([BF01] D. Boneh and M. Franklin, “Identity based encryption from the Weil paring”, extended abstract in Advances in Cryptology—Crypto 2001, Lecture Notes in Computer Science, Vol. 2139, Springer-Verlag, pp. 213-229, August 2001; see also http://eprint.iacr.org/2001/090/). The IBE system is a public key encryption system in which an arbitrary string, such as for example a telephone number or e-mail address, is used as a public key; because the public key and its owner are easily associated, the system has attracted attention as a means of greatly reducing the complexity of key management in standard public-key encryption. In the IBE system, a third party, called a secret key generator, is necessary for generation of a secret key. The secret key generator uses a master-secret key to generate a secret key for each user, and distributes the secret keys to the users. The secret key generator can decrypt all the ciphertext encrypted by the public keys of users, and so must be a third party who can be trusted.

In the prior art, various technologies have been proposed to realize a rights delegation system using either the PKE system or the IBE system. Specifically, delegation systems such as that shown in FIG. 5 are in use. Here, A is a decryption rights delegator device, B is a decryption rights delegatee device, and P is a ciphertext conversion device; the PKG (Public Key Generator) is a secret key generation device which generates secret keys for the IBE system and re-encryption keys. In each of these systems, generation of a re-encryption key and generation of a secret key in the IBE system are performed in the order indicated in FIG. 6. The PKE system and IBE system each have their respective advantages and disadvantages, and are normally used selectively according to the requirements of the application. In light of the circumstances of application of public key encryption of recent years, in which a mixture of the PKE system and IBE system may be used, a situation in which decryption rights delegation is not possible unless users employ only one of the public key encryption systems means incomplete flexibility with respect to content sharing. However, with existing technology there is the problem that encryption rights delegation cannot be realized among users who use different public key encryption systems.

With respect to delegation systems between users using only the IBE system, a method which utilizes the technology described in the above Reference 1 has been proposed. In the technology described in Reference 1, as shown in FIG. 10, the master-secret key is divided into two portions by the secret key generation device, and one portion is transmitted to the decryption rights delegates device (B), while the other portion is transmitted to the ciphertext conversion device (P); hence as shown in FIG. 11, there is the problem that, in the event of collusion between the delegates using the decryption rights delegatee device (B) and the ciphertext converter using the ciphertext conversion device (P), the master-secret key of the secret key generator can be reconstructed, so that security cannot be ensured.

### SUMMARY OF THE INVENTION

This invention was devised in order to resolve the above two problems, and has as an object the provision of a ciphertext decryption rights delegation system enabling conversion by a ciphertext converter from PKE system ciphertext into IBE system ciphertext. A further object is to provide a ciphertext decryption rights delegation system, in a delegation system configuration in which only the IBE system is used among users, such that the master-secret key of the secret key generator cannot be reconstructed even when there is collusion between a ciphertext converter and a decryption rights delegatee.

A decryption rights delegation system of this invention, in which ciphertext decryption rights delegation is performed by a decryption rights delegator device and a decryption rights delegatee device, and comprising a ciphertext conversion device which performs conversion using a re-encryption key such that ciphertext transmitted from the decryption rights delegator device can be decrypted by the decryption rights delegatee device, is characterized in comprising a master-secret key processing unit, for generating, from the master-secret key of an identity based encryption system, secret keys and auxiliary information for the identity based encryption system, and a re-encryption key generation unit, for generating, based on the auxiliary information generated by the master-secret key processing unit, a re-encryption key for conversion of ciphertext, encrypted by the decryption rights delegator device, so that the decryption rights delegatee device can perform decryption using the identity based encryption system secret key.

Further, a decryption rights delegation system of this invention, comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, is characterized in that the secret key generation device comprises a first storage unit for storing the master-secret key, a master-secret key processing unit for generating, based on the master-secret key stored by the first storage unit and an identity based encryption system public key selected arbitrarily by the decryption rights delegates device, auxiliary information and an identity based encryption system secret key used in decryption by the decryption rights delegatee device and corresponding to the identity based encryption public key, a secret key transmission unit for transmitting an identity based encryption system secret key generated by the master-secret key processing unit to the decryption rights delegatee device, and an auxiliary information transmission unit for transmitting auxiliary information generated by the master-secret key processing unit to the decryption rights delegator device; and is characterized in that the decryption rights delegator device comprises a second storage unit for storing the public key encryption system public key and secret key, an auxiliary information reception unit for receiving auxiliary information from the secret key generation device, a re-encryption key generation unit for generating, based on the secret key stored in the second storage unit and auxiliary information received by the auxiliary information reception unit, a re-encryption key used by the ciphertext conversion device when converting ciphertext, and a re-encryption key transmission unit for transmitting the re-encryption key generated by the re-encryption key generation unit to the ciphertext conversion device.

Further, in a decryption rights delegation system of the above-described invention, the decryption rights delegator device may comprise a public key encryption processing unit for using a public key stored by the second storage unit to encrypt plaintext and generate ciphertext, and a ciphertext transmission unit for transmitting ciphertext generated by the public key encryption processing unit to the ciphertext conversion device; in that the ciphertext conversion device comprises a re-encryption key reception unit for receiving a re-encryption key from the decryption rights delegator device, a ciphertext reception unit for receiving ciphertext from the decryption rights delegator device, a ciphertext conversion processing unit for converting ciphertext received by the ciphertext reception unit based on a re-encryption key received by the re-encryption key reception unit, and a converted ciphertext transmission unit for transmitting ciphertext converted by the ciphertext conversion processing unit to the decryption rights delegatee device; and in that the decryption rights delegatee device comprises a secret key reception unit for receiving a secret key for the identity based encryption system transmitted from the secret key generation device, a converted ciphertext reception unit for receiving converted ciphertext from the ciphertext conversion device, and an identity based encryption processing unit for decrypting ciphertext received by the converted ciphertext reception unit based on the identity based encryption system secret key received by the secret key reception unit.

Further, a secret key generation device of this invention, in a decryption rights delegation system comprising a decryption rights, delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, is characterized in comprising a first storage unit for storing the master-secret key, a master-secret key processing unit for generating identity based encryption system secret keys and auxiliary information for use in decryption by the decryption rights delegatee device, based on the master-secret key stored by the first storage unit and an identity based encryption system public key chosen arbitrarily by the decryption rights delegates device and corresponding to the identity based encryption public key, and a transmission unit for transmitting an identity based encryption system secret key generated by the master-secret key processing unit to the decryption rights delegatee device, to cause generation by the decryption rights delegator device of a re-encryption key for use by the ciphertext conversion device.

Further, a decryption rights delegator device of this invention, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, is characterized in comprising a second storage unit for storing the public key of the public key encryption system and a secret key, an auxiliary information reception unit for receiving from the secret key generation device both the master-secret key and auxiliary information generated based on an identity based encryption system public key selected arbitrarily by the decryption rights delegatee device, a re-encryption key generation unit for generating a re-encryption key based on the secret key stored in the second storage unit and on the auxiliary information received by the auxiliary information reception unit for use when the ciphertext conversion device converts ciphertext, and a re-encryption key transmission unit for transmitting the re-encryption key generated by the re-encryption key generation unit to the ciphertext conversion device.

Further, a decryption rights delegation system of this invention, comprising a decryption rights delegator device which performs encryption using an identity based encryption system, a decryption rights delegatee device which performs encryption using an identity based encryption system, a secret key generation device which generates a secret key used in an identity based encryption system based on a master-secret key, and a ciphertext conversion device which converts ciphertext encrypted and transmitted by the decryption rights delegator device such that the decryption rights delegatee device can decrypt the ciphertext, is characterized in that the secret key generation device comprises a first storage unit for storing the master-secret key, a master-secret key processing unit for generating, based on the master-secret key stored by the first storage unit and an identity based encryption system public key selected arbitrarily by the decryption rights delegator device, auxiliary information and an identity based encryption system secret key used in decryption by the decryption rights delegatee device, a re-encryption key generation unit for generating a re-encryption key based on the master-secret key stored by the first storage unit and on the auxiliary information, a secret key transmission unit for transmission to the decryption rights delegates device of an identity based encryption system secret key generated by the master-secret key processing unit, and a re-encryption key transmission unit for transmission to the ciphertext conversion device of the re-encryption key generated by the re-encryption key generation unit.

Further, in a decryption rights delegation system of the above-described invention, the decryption rights delegator device may comprise an identity based encryption processing unit for encrypting plaintext to generate ciphertext using an arbitrarily selected identity based encryption public key, and a ciphertext transmission unit for transmitting the ciphertext generated by the identity based encryption processing unit to the ciphertext conversion device; in that the ciphertext conversion device comprises a re-encryption key reception unit for receiving a re-encryption key from the secret key generation device, a ciphertext reception unit for receiving ciphertext from the decryption rights delegator device, a ciphertext conversion processing unit for converting ciphertext received from the ciphertext reception unit based on the re-encryption key received by the re-encryption key reception unit, and a converted ciphertext transmission unit for transmitting ciphertext converted by the ciphertext conversion processing unit to the decryption rights delegatee device; and in that the decryption rights delegatee device comprises a secret key reception unit for receiving the identity based encryption secret key from the secret key generation device, a converted ciphertext reception unit for receiving the ciphertext from the ciphertext conversion device, and an identity based encryption processing unit for decrypting ciphertext received by the converted ciphertext reception unit based on the identity based encryption secret key received by the secret key reception unit.

Further, a secret key generation device of this invention, in a decryption rights delegation system comprising a decryption rights delegator device which performs encryption using an identity based encryption system, a decryption rights delegates device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, is characterized in comprising a first storage unit for storing the master-secret key, a master-secret key processing unit for generating identity based encryption system secret keys and auxiliary information for use in decryption by the decryption rights delegatee device, based on the master-secret key stored by the first storage unit and an identity based encryption system public key chosen arbitrarily by the decryption rights delegator device, a re-encryption key generation unit for generating a re-encryption key based on the master-secret key stored by the first storage unit and on the auxiliary information, a secret key transmission unit for transmitting to the decryption rights delegatee device an identity based encryption system secret key generated by the master-secret key processing unit, and a re-encryption key transmission unit for transmitting to the ciphertext conversion device a re-encryption key generated by the re-encryption key generation unit.

Further, computer-readable recording media of this invention has recorded a ciphertext decryption rights delegation program, which causes a computer, in a decryption rights delegation system in which ciphertext decryption rights delegation is performed between a decryption rights delegator device and a decryption rights delegatee device, comprising a ciphertext conversion device which uses a re-encryption key to convert ciphertext transmitted from the decryption rights delegator device so as to enable decryption by the decryption rights delegatee device, to execute a procedure of generating from a master-secret key of an identity based encryption system a secret key for the identity based encryption system and auxiliary information, and a procedure, based on the generated auxiliary information, of generating a re-encryption key to convert ciphertext encrypted by the decryption rights delegator device so as to enable the decryption rights delegatee device to perform decryption using the identity based encryption system secret key.

Further, computer-readable recording media of this invention has recorded a ciphertext decryption rights delegation program, which causes a computer, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, to execute a procedure of using the secret key generation device to store the master-secret key in a first storage unit, a procedure, based on the master-secret key stored in the first storage unit and an identity based encryption system public key selected arbitrarily by the decryption rights delegatee device, to generate auxiliary information and an identity based encryption system secret key corresponding to the identity based encryption public key and to be used when the decryption rights delegatee device performs decryption, a procedure of transmitting the generated identity based encryption system secret key to the decryption rights delegatee device, a procedure of causing execution of a procedure to transmit the generated auxiliary information to the decryption rights delegator device and of using the decryption rights delegator device to store the public key encryption system public key and secret key in a second storage unit, a procedure of receiving the auxiliary information from the secret key generation device, a procedure of generating a re-encryption key to be used when the ciphertext conversion device converts ciphertext, based on the secret key stored by the second storage unit and on the received auxiliary information, and a procedure of transmitting the generated re-encryption key to the ciphertext conversion device.

Further, computer-readable recording media of this invention has recorded a secret key generation program, which causes the computer of a secret key generation device, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, to execute a procedure of causing storage of the master-secret key in a first storage unit, a procedure, based on a master-secret key stored in the first storage unit and on an identity based encryption system public key selected arbitrarily by the decryption rights delegatee device, of generating auxiliary information and an identity based encryption secret key corresponding to the identity based encryption public key, for use when the decryption rights delegatee device performs decryption, and a procedure of transmitting the generated identity based encryption system secret key to the decryption rights delegates device, transmitting the generated auxiliary information to the decryption rights delegator device, and causing the decryption rights delegator device to generate a re-encryption key for use by the ciphertext conversion device.

Further, computer-readable recording media of this invention has recorded a decryption rights delegation program, which causes the computer of a decryption rights delegator device, in a decryption rights delegation system comprising a decryption rights delegator device which performs encryption using a standard public key encryption system, a decryption rights delegates device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, to execute a procedure of causing storage of a public key of the public key encryption system and a secret key in a second storage unit, a procedure of receiving, from the secret key generation device, auxiliary information generated based on the master-secret key and on an identity based encryption system public key arbitrarily selected by the decryption rights delegatee device, a procedure of generating a re-encryption key based on the secret key stored in the second storage unit and on the received auxiliary information, for use when the ciphertext conversion device converts ciphertext, and a procedure of transmitting the generated re-encryption key to the ciphertext conversion device.

Further, computer-readable recording media of this invention has recorded a decryption rights delegation program, which causes the computer of a decryption rights delegator device, in a decryption rights delegation system comprising a decryption rights delegator device which performs encryption using an identity based encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, to execute a procedure of causing storage by the secret key generation device of the master-secret key in a first storage unit, a procedure, based on the master-secret key stored in the first storage unit and on an identity based encryption system public key arbitrarily selected by the decryption rights delegator device, of generating auxiliary information and an identity based encryption system secret key to be used by the decryption rights delegates device when performing decryption, a procedure of generating a re-encryption key based on the master-secret key stored in the first storage unit and on the auxiliary information, a procedure of transmitting the generated identity based encryption system secret key to the decryption rights delegatee device, and a procedure of transmitting the generated re-encryption key to the ciphertext conversion device.

Further, computer-readable recording media of this invention has recorded a secret key generation program, which causes the computer of a secret key generation device, in a decryption rights delegation system comprising a decryption rights delegator device which performs encryption using an identity based encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by the decryption rights delegator device, so as to enable decryption of the ciphertext by the decryption rights delegatee device, to execute a procedure of causing storage of the master-secret key in a first storage unit, a procedure, based on a master-secret key stored in the first storage unit and on an identity based encryption system public key selected arbitrarily by the decryption rights delegator device, of generating auxiliary information and an identity based encryption secret key for use when the decryption rights delegatee device performs decryption, a procedure of generating a re-encryption key based on the master-secret key stored in the first storage unit and on the auxiliary information, a procedure of transmitting the generated identity based encryption system secret key to the decryption rights delegatee device, and a procedure of transmitting the generated re-encryption key to the ciphertext conversion device.

### BRIEF DESCRIPTION OF THE DRAWINGS

FIG. 1 is a schematic block diagram of a delegation system of a first embodiment;

FIG. 2 shows procedures of processing to generate a secret key and a re-encryption key in the first embodiment;

FIG. 3 shows procedures for ciphertext encryption and decryption processing in the first embodiment;

FIG. 4 shows the procedure of the first embodiment in comparison with a conventional procedure;

FIG. 5 shows system configurations of the conventional system in comparison with the first embodiment;

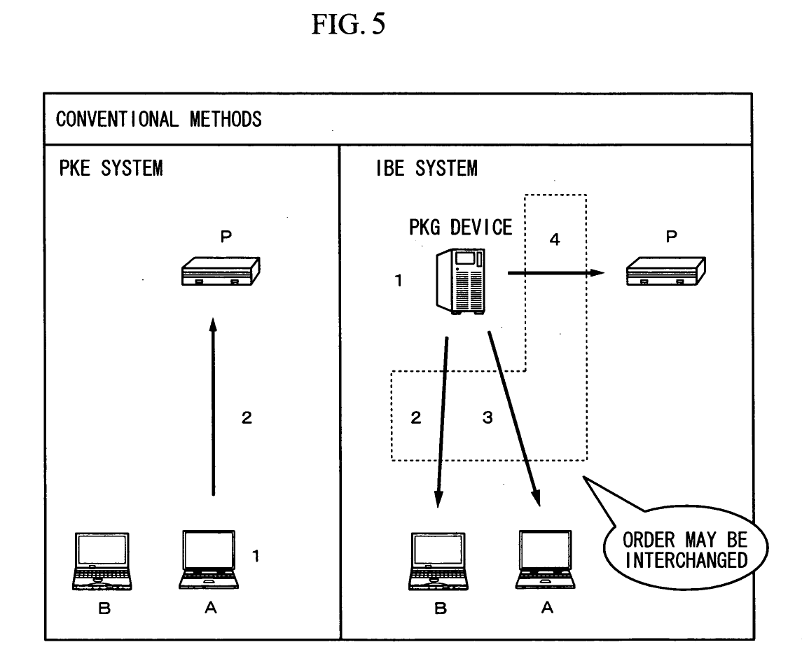

FIG. 6 shows conventional procedures of processing to generate a secret key and a re-encryption key in comparison with the first embodiment;

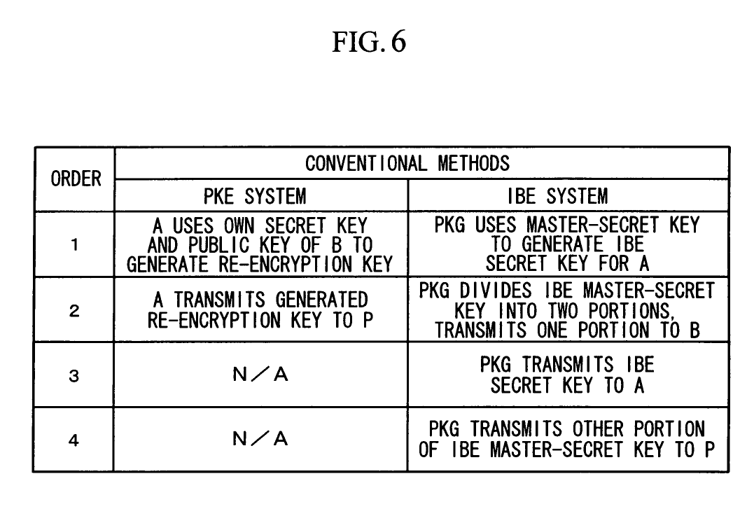

FIG. 7 is a schematic block diagram of a delegation system of a second embodiment;

FIG. 8 shows procedures of processing to generate a secret key and a re-encryption key in the second embodiment;

FIG. 9 shows the procedures for ciphertext encryption and decryption processing in the second embodiment;

FIG. 10 shows conventional procedures of processing in comparison with the second embodiment; and,

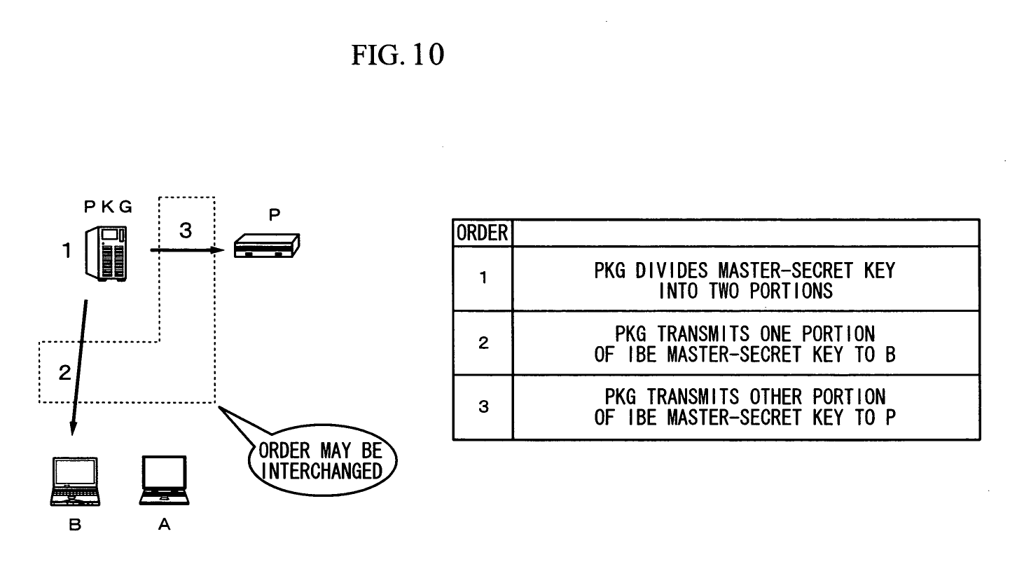

FIG. 11 shows problems of the conventional procedures in comparison with the second embodiment.

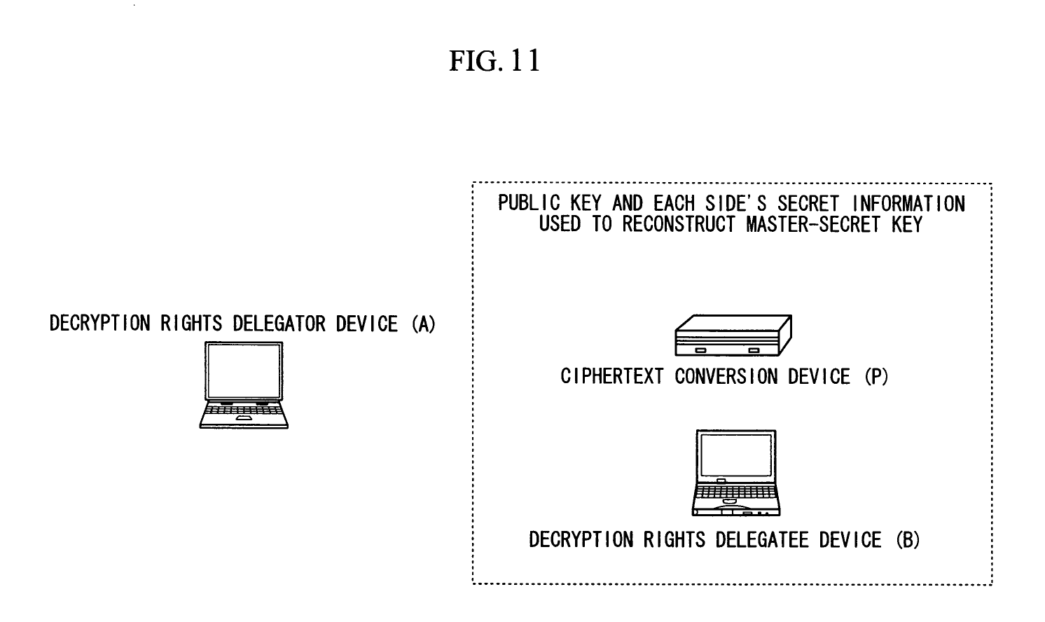

### DESCRIPTION OF THE PREFERRED EMBODIMENTS

Below, embodiments of the invention are explained referring to the drawings. In the following embodiments, the IBE system proposed in Reference 2 ([BB04] D. Boneh and X. Boyen, “Efficient selective-id secure identity based encryption without random oracle”, Advances in Cryptology—EUROCRYPT '04, Lecture Notes in Computer Science, LNCS 3027, pp. 223-238, Springer-Verlag, 2004) is adopted, in a delegation system from users using a PKE system to users using an IBE system.

### First Embodiment

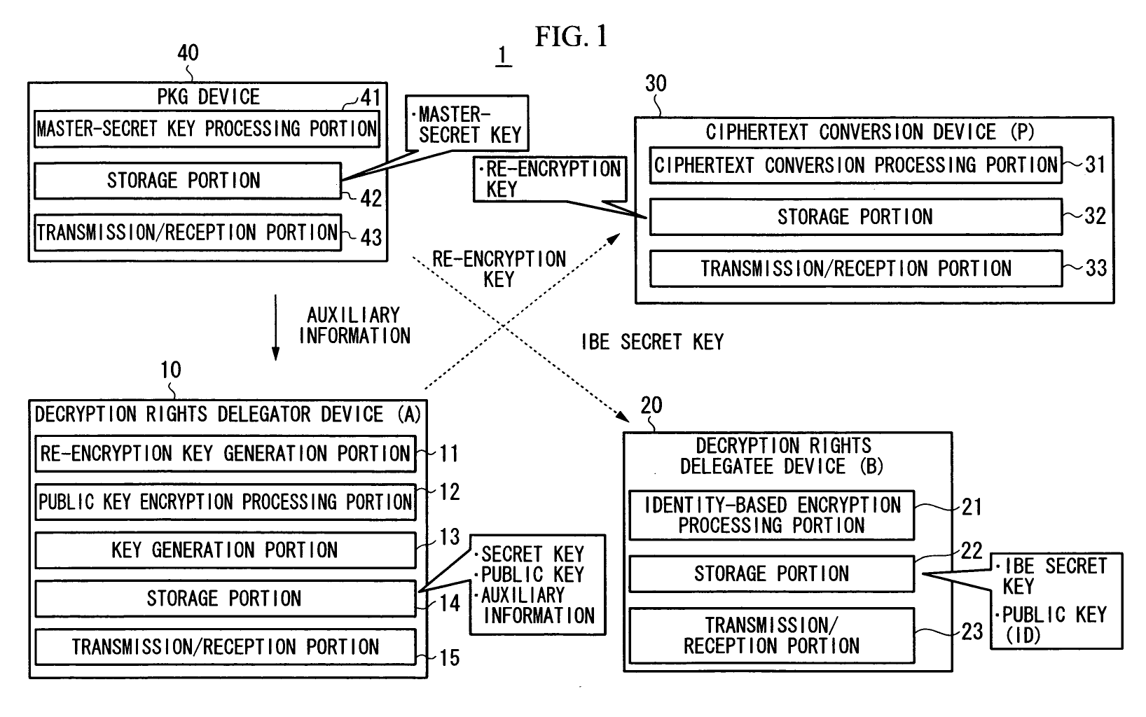

Below, a first embodiment of the invention is explained, referring to FIG. 1 through FIG. 4. In the first embodiment, the configuration of a ciphertext decryption rights delegation system (hereafter called a “delegation system”) enabling conversion from PKE system ciphertext to IBE system ciphertext is explained.

FIG. 1 shows the configuration of the delegation system 1 of the first embodiment. The solid-line arrow between equipment in FIG. 1 indicates communication via an ordinary circuit, that is, communication which may be leaked to a third party, but for which tampering of communication data by a third party does not occur; dashed-line arrows indicate communication via circuits which can be made secure, that is, for which secrecy can be secured and tampering can be prevented.

The delegation system I comprises a decryption rights delegator device 10 (hereafter also called “A”); a decryption rights delegates device 20 (hereafter also called “B”); a ciphertext conversion device 30 (hereafter also called “P”); and a PKG device (secret key generation device) 40. The decryption rights delegator device 10 (A) adopts PKE system encryption; the decryption rights delegatee device 20 (B) adopts IBE system encryption.

In the PKG device 40, the storage portion 42 stores in advance a master-secret key (mk). The master-secret key processing portion 41 generates a secret key (d_{ID}) corresponding to the device adopting IBE system encryption, such as the decryption rights delegatee device 20, and generates auxiliary information (e_{ID}). The transmission/reception portion 43 transmits and receives information with the decryption rights delegator device 10 and decryption rights delegatee device 20.

In the decryption rights delegator device 10, the storage portion 14 stores a secret key and public key generated by the key generation portion 13, and stores auxiliary information transmitted from the PKG device 40. The re-encryption key generation portion 11 generates a re-encryption key (rk_{ID}) using the secret key stored in the storage portion 14 and the auxiliary information transmitted from the PKG device 40; the re-encryption key is used by the ciphertext conversion device 30. The public key encryption processing portion 12 executes an algorithm to perform PKE encryption using the public key stored in the storage portion 14, and executes an algorithm to perform decryption using the secret key stored in the storage portion 14. The transmission/reception portion 15 performs transmission and reception of information with the PKG device 40 and ciphertext conversion device 30.

In the decryption rights delegatee device 20, the storage portion 22 stores the IBE system public key (ID) selected arbitrarily by the user of the decryption rights delegatee device 20, and stores the secret key corresponding to the public key generated and transmitted from the PKG device 40. The identity based encryption processing portion 21 performs encryption based on the IBE system using the public key stored in the storage portion 22, and executes an algorithm to perform decryption using the secret key stored in the storage portion 22. The transmission/reception portion 23 performs transmission and reception with the PKG device 40 and ciphertext conversion device 30.

In the ciphertext conversion device 30, the storage portion 32 stores the re-encryption key generated and transmitted by the decryption rights delegator device 10. Ciphertext transmitted from the decryption rights delegator device 10 is received by the transmission/reception portion 33; the ciphertext re-encryption portion 31 uses the re-encryption key stored in the storage portion 32 to convert the received ciphertext, and the converted ciphertext is transmitted to the decryption rights delegates device 20 by the transmission/reception portion 33. The transmission/reception portion 33 performs transmission and reception of information with the decryption rights delegator device 10 and decryption rights delegatee device 20.

Next, processing to generate a secret key for the decryption rights delegates device 20, performed by the PKG device 40 in the delegation system 1 of the first embodiment, and processing to generate a re-encryption key for the ciphertext conversion device 40 by the decryption rights delegator device 10, are explained.

First, the various symbols used in the explanation below are defined as follows.

### DEFINITIONS

[symbol] : Set of natural numbers other than 0 up to complex number p exclusive (hereafter denoted by Zₚ*),

[symbol] : Groups of prime order p which can define a bilinear map (hereafter denoted by G and G₁),

ê: [symbol] : A bilinear map,

ID: The ID of a user (rights delegatee) using identity based encryption. The bit size necessary for binary representation of ID is taken to be 1,

[symbol] : When ID is represented in binary notation, the set of indexes corresponding to digits for which the bit is “1”. For example, if ID= [symbol] 110, then ={2,3,6}, and if ID=001001, then = [symbol] , 4}.

As premises of the processing to generate the secret key of the decryption rights delegates device 20 and the re-encryption key of the ciphertext conversion device 30, as initialization processing the PKG device 40 uses a security parameter k, randomly selects a generator gεG in the group G, and selects random elements g₂, hεG in the group G. Then, a random element αεZₚ* in Zₚ* is selected, and with mk=g₂^{α}, g₁=g^{α}, and parms=(g,g₁,g₂,h), the master-secret key mk and public parameters parms are stored in the storage portion 42. Here, parms are public parameters which can be accessed by a third party.

In the decryption rights delegator device 10 (A), the key generation portion 13 is used to perform PKE system key generation. The key generation portion 13 takes as input the public parameters parms made available by the PKG device 40, and selects random elements β,θεZₚ* in Zₚ*. Then, with g₃=g₁^{β} and g₄=g^{θ}, the public key pk and the decryption secret key sk are respectively generated as pk=(g₃,g₄) and sk=β, with θ as a secret key for re-encryption key generation. The generated values of pk, sk, θ are stored in the storage portion 14.

Under processing under the above premises, the processing to generate the secret key for the decryption rights delegates device 20 and the re-encryption key for the ciphertext conversion device 30 is performed as follows.

First, the master-secret key processing portion 41 of the PKG device 40 uses the master-secret key (mk) to generate an IBE system secret key (d_{ID}) for the decryption rights delegates device 20 (B) and auxiliary information (e_{ID}). Specifically, the master-secret key processing portion 41 takes as input the master-secret key mk=g₂^{α}, the user ID which is the IBE system public key of the decryption rights delegatee device 20 (B), and the public parameters parms, selects a random element uεZₚ* in Zₚ*, and generates the secret key (d_{ID}) and auxiliary information (e_{ID}) using the following equation (1):

(d_{ID},e_{ID})=(g₂^{α}(g₁^{ID}h)^{u},g^{u}) (1)

The master-secret key processing portion 41 of the PKG device 40 then uses a secure communication circuit to transmit the IBE secret key (d_{ID}) to the decryption rights delegatee device 20 (B) via the transmission/reception portion 43 (step (2)). The decryption rights delegatee device 20 (B) stores the received secret key (d_{ID}) in the storage portion 22. The master-secret key processing portion 41 of the PKG device 40 also transmits the auxiliary information to the decryption rights delegator device 10 (A) via a tamper-proof communication path, using the transmission/reception portion 43 (step (3)).

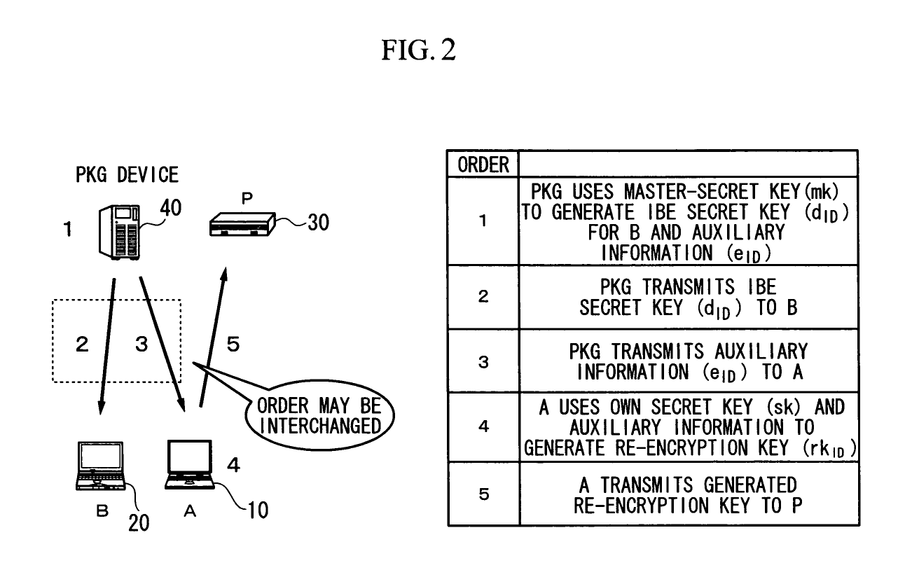

The re-encryption key processing portion 11 of the decryption rights delegator device 10 (A), upon receiving the auxiliary information via the transmission/reception portion 15, records the received auxiliary information in the storage portion 14, and uses its own secret key (sk,θ) and auxiliary information (e_{ID}) stored in the storage portion 14 to generate a re-encryption key (rk_{ID}) (step (4)). Specifically, taking as input the decryption secret key sk=β, secret key for re-encryption key generation 0, auxiliary information e_{ID}=g^{u} corresponding to B20 indicated by ID, and public parameters parms made accessible by the PKG device 40, the re-encryption key is then rk_{ID}=(g^{u/β},g^{u},θ). Then, the re-encryption key generation portion 11 of the decryption rights delegator device 10 (A) transmits the generated re-encryption key (rk_{ID}) via a secure communication path to the ciphertext conversion device 30 (P) using the transmission/reception portion 15. The ciphertext conversion device 30 (P) records the re-encryption key (rk_{ID}) received via the transmission/reception portion 33 in the storage portion 32 (step (5)). As shown in FIG. 2, the order of processing of step (2) and step (3) may be reversed.

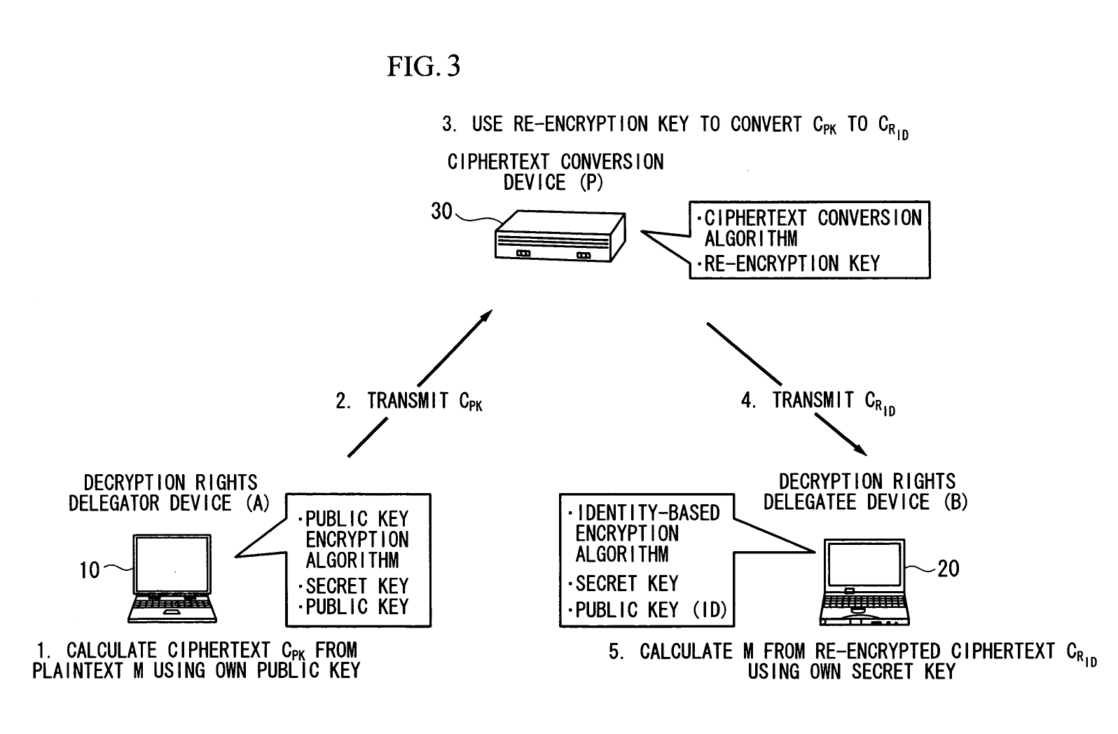

Next, processing to encrypt, convert, and decrypt plaintext, using the public key, re-encryption key, and secret key generated as described above, is explained referring to FIG. 3.

First, the public key encryption processing portion 12 of the decryption rights delegator device 10 (A) encrypts the plaintext M to be shared with 20 (B) using the PKE system public key, to generate ciphertext Cₚₖ. Specifically, taking as input the public key pk=(g₃,g₁), plaintext MεG₁, and the public parameters parms, a random element rεZₚ* in Zₚ* is selected, and the following equation (2) is used to generate the ciphertext Cₚₖ (step (1)):

C_{PK}=(g₄^{r},g₃^{r},h^{r},M·ê(g₁,g₂)^{r})ε [symbol] × [symbol] (2)

Next, the public key encryption processing portion 12 of the decryption rights delegator device 10 (A) transmits the generated ciphertext Cₚₖ to the ciphertext conversion device 30 (P) via the transmission/reception portion 15 (step (2)). The ciphertext conversion processing portion 31 of the ciphertext conversion device 30 (P) takes as input the re-encryption key rk_{ID}=(g^{u/β},g^{u},θ) stored in the storage portion 32 and the public parameters parms and ciphertext Cₚₖ=(C₁,C₂,C₃,C₄), and based on the following equation (3), converts Cₚₖ to generate the converted ciphertext C_{R}_{_{ID}} (step (3)):

C_{R}_{_{ID}}=(C′₁,C′₂)=(C₁^{1/θ},C₄·ê(g^{u/β},C₂^{ID})·ê(g^{u},C₃))ε [symbol] × [symbol] (3)

The ciphertext conversion processing portion 31 of the ciphertext conversion device 30 (P) transmits the generated converted ciphertext C_{R}_{_{ID}} to the decryption rights delegatee device 20 (B) via the transmission/reception portion 33 (step (4)). The identity based encryption processing portion 21 of the decryption rights delegatee device 20 (B) takes as input the secret key (d_{ID}) and public parameters parms stored in the storage portion 22 and the converted ciphertext C_{R}_{_{ID}}=(C₁′,C₂′) received via the transmission/reception portion 23, and performs computations according to the following equation (4) to reproduce the plaintext M (step (5)):

M=C′₂/ê(d_{ID},C′₁) (4)

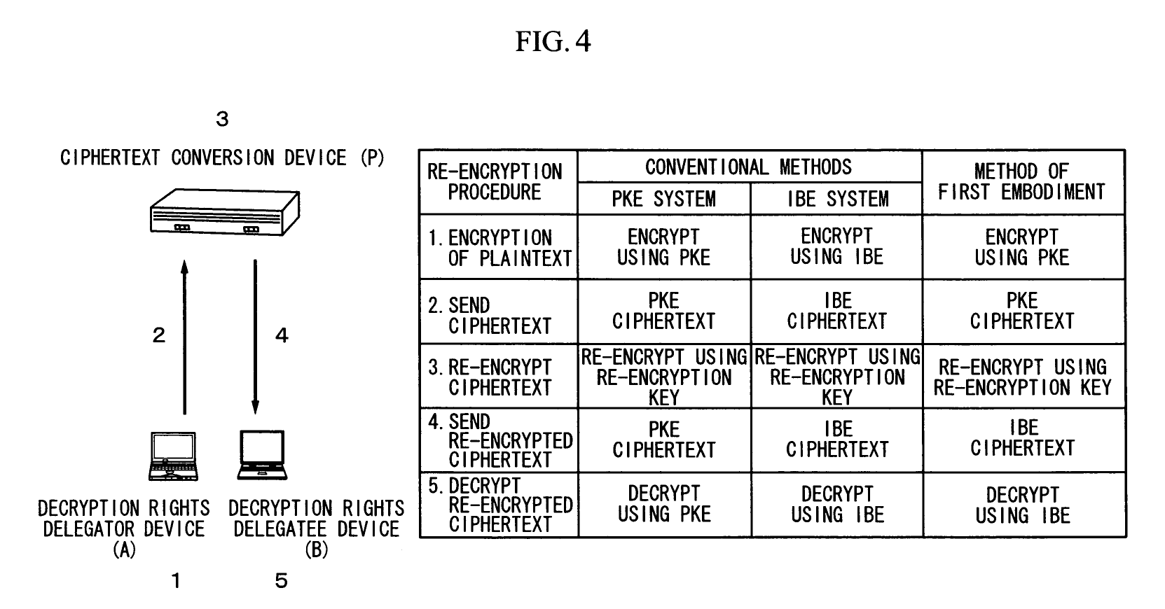

By means of the above configuration, whereas in the prior art a delegation system could not be realized when both A and B adopted only one among a PKE system and an IBE system, as shown in FIG. 4, ciphertext encrypted by the decryption rights delegator device 10 (A) using a PKE system public key can be decoded by a decryption rights delegation device 20 (B) which adopts an IBE system.

The security of the delegation system 1 realized by means of the above-described configuration is proven as described below.

(Definition 1)

For randomly chosen integers

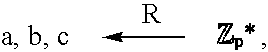

a random generator

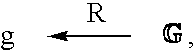

and an element

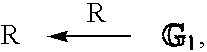

we define the advantage of an algorithm [symbol] in solving the decision Bilinear Diffie-Hellman (dBDH) problem as follows:

[symbol]

=|Pr[ [symbol] (g,g^{a},g^{b},g^{c},ê(g,g)^{abc})=0]−Pr[ [symbol] (g,g^{a},g^{b},g^{c},R)=0]|

where the probability is over the random choice of generator gε [symbol] , the randomly chosen integers a, b, c, the random choice of Rε [symbol] , and the random bits used by A. We say that the (k, t, ε)-dBDH assumption holds in [symbol] if no t-time algorithm has advantage at least ε in solving the dBDH problem in [symbol] under a security parameter k.

(Security Notion)

(Chosen Plaintext Security)

We model chosen plaintext security for a hybrid proxy re-encryption system as a game between an adversary [symbol] and a challenger C. In this game, the adversary is allowed to adaptively choose the secret key queries and re-encryption key queries. Intuitively, these queries correspond to the situation where the adversary compromises some part of the proxy (or proxies) and some delegatees. Since the adversary obviously wins the game if it obtains both delegatee's secret key and the corresponding re-encryption key involving the same identity, she is not allowed to ask such query. More precisely, IND-ID-CPA security is defined as follows:

<Setup>
The challenger C generates (parms,mk). C also generates (pk, sk). C gives (parms, pk), to [symbol] , keeping (mk, sk) to itself.

<Phase 1>
Given (parms, pk), [symbol] adaptively queries the challenger for either an IBE secret key or a re-encryption key. When A queries the challenger at a point IDᵢ, C responds as follows:
   Secret key queries: C generates a secret key sk_{ID}_{ᵢ} for IDi and returns it to the adversary.
   Re-encryption key queries: C generates sk_{ID}_{ᵢ}, C generates d_{ID}_{ᵢ} and e_{ID}_{ᵢ} from sk_{ID}_{ᵢ}. C generates a re-encryption key rk_{ID}_{ᵢ} from e_{ID}_{ᵢ} and sk. C returns rk_{ID}_{ᵢ} to the adversary.

<Challenge>
After some queries, [symbol] selects two equal length plaintexts M₀, M₁ε [symbol] and sends them to C. C picks

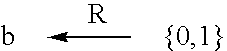

and computes a ciphertext C_{PK}_{_{b}} of the selected message M_{b}. C returns C_{PK}_{_{b}} to [symbol] .

<Phase 2>
[symbol] A continues to issue queries as in Phase 1, and C responds as before.

<Guess>
Finally, [symbol] outputs a guess \tilde{b}ε{0, 1}.

The adversary [symbol] wins if \tilde{b}=b. The hybrid proxy re-encryption system is secure in the sense of IND-ID-CPA if |Pr[\tilde{b}=b]−½| is negligible.

(Definition 2)

Let [symbol] be an adversary against the hybrid proxy re-encryption system. Define the IND-ID-CPA advantage of [symbol] as follows:

Adv_{hyd}^{idcpa}( [symbol] )=2(Pr[\tilde{b}=b]−½)

We say that a hybrid proxy re-encryption system is (k, t, q, ε) adaptive chosen plaintext secure if for any t time IND-ID-CPA adversary [symbol] that makes at most q chosen queries under a security parameter k we have that Adv_{hyd}^{idcpa}( [symbol] )<ε. As shorthand, we say that a hybrid proxy re-encryption system is (k, t, q, ε) INDID-CPA secure.

Note that this game encompasses the notion of semantic security for the PKE system, as well as that for the IBE system, and also the notion that a set of reencryption keys cannot be “combined” to form new re-encryption keys for other identities. For example, if the PKE system is not semantically secure, then the adversary can win the game by simply distinguishing the challenge ciphertext.

(Theorem 1)

Suppose that the (k, t, ε)-dBDH assumption holds. Then the hybrid proxy re-encryption system is (k, t′, q, ε) IND-ID-CPA secure for any q, k, and t′<t−θ(τq) where τ is the maximum time for an exponentiation in [symbol] .

(Proof)

Let [symbol] be an adversary against the hybrid proxy re-encryption system in the IND-ID-CPA sense. We construct an adversary B which solves the dBDH problem in [symbol] by utilizing [symbol] . Providing that [symbol] is given an input (g, Γ₁, Γ₂, Γ₃, X)=(g, g^{a}, g^{b}, g^{c}, X), where x=ê(g,g)^{abc} or

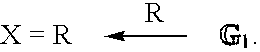

We describe how [symbol] works in the following:

<Setup>
To generate the system parameters, algorithm [symbol] picks

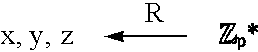

and sets g₁=Γ₁, g₂=Γ₂, g₄=g^{x}, g₃=g^{y} and h=g^{z}. It gives [symbol] the system parameters parms=(g, g₁, g₂, h), and pk=(g₃, g₄). Note that the corresponding PKG's master-secret key, which is unknown to [symbol] , is g₂^{a}=g^{ab}ε [symbol] .
<Phase 1> Given pk and parms, [symbol] asks some queries to the challenger. When [symbol] queries the challenger at a point IDᵢ, [symbol] rejects the query if ID=0. Otherwise [symbol] works as follows:
   Secret key queries: [symbol] selects

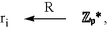

sets

$${sk}_{{ID}_{i}} = ( {d}_{0} , {d}_{1} ) = ( {g}_{2}^{\frac{- z}{{ID}_{i}}} \text{(} {g}_{1}^{{ID}_{i}} {g}^{z} {\text{)}}^{{r}_{i}} , {g}_{2}^{\frac{- 1}{{ID}_{i}}} {g}^{{r}_{i}} )$$

and returns it to [symbol] .
Re-encryption key queries: [symbol] selects

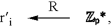

sets

$${rk}_{{ID}_{i}} = ( {g}_{1}^{{r}_{i}^{′}} , {g}^{y {r}_{i}^{′}} , x )$$

and returns it to [symbol] .

<Challenge>
After some queries, [symbol] selects two equal length plaintexts M₀, M₁ε [symbol] . Given (M0,M1), [symbol] selects

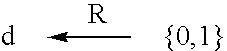

and sets

C_{PK}_{_{d}}=(Γ₃^{x}, Γ₃^{y}, Γ₃^{z}, M_{d}·X) [symbol]
returns C_{PK}_{_{d}} to [symbol] . Notice that if X=ê(g,g)^{abc}=ê(g₁,g₂)^{c} then C_{PK}_{_{d}} is a valid encryption of M_{d}. On the other hand, if X is uniform and independent in [symbol] then C_{PK}_{_{d}} is independent of d in the adversary's view.

<Phase 2>
[symbol] continues to issue queries as in Phase 1, and [symbol] responds as before.

<Solve>
Finally, [symbol] outputs a guess d′ε{0, 1}. [symbol] concludes its own game by outputting a guess as follows. If d′=d then [symbol] outputs 1 meaning X=ê(g,g)^{abc}. Otherwise, it outputs 0 meaning X=R.

We claim that [symbol] generates a valid secret key and the corresponding auxiliary information for IDᵢ. To see this, let

$${\tilde{u}}_{i} = {r}_{i} - \frac{b}{{ID}_{i}}$$

Then we have that

$$\begin{matrix}( {d}_{{ID}_{i}} , {e}_{{ID}_{i}} ) = ( {{g}_{2}^{\frac{- z}{{ID}_{i}}} ( {g}_{1}^{{ID}_{i}} {g}^{z} )}^{{r}_{i}} , {g}_{2}^{\frac{- 1}{{ID}_{i}}} {g}^{{r}_{i}} ) = ( \frac{{{g}_{2}^{α} ( {g}_{1}^{{ID}_{i}} {g}^{z} )}^{{r}_{i}}}{{( {g}_{1}^{{ID}_{i}} {g}^{z} )}^{\frac{b}{{ID}_{i}}}} , {g}^{{r}_{i} - \frac{b}{{ID}_{i}}} ) \\ = ( {{g}_{2}^{α} ( {g}_{1}^{{ID}_{i}} {g}^{z} )}^{{r}_{i} - \frac{b}{{ID}_{i}}} , {g}^{{r}_{i} - \frac{b}{{ID}_{i}}} ) \\ = ( {{g}_{2}^{α} ( {g}_{1}^{{ID}_{i}} h )}^{{\tilde{u}}_{i}} , {g}^{{\tilde{u}}_{i}} )\end{matrix}$$

We also claim that [symbol] can perfectly simulate the re-encryption key for IDᵢ since it looks random and independent of any other values if the adversary does not obtain the corresponding secret key. Therefore, we conclude the theorem 1.

The secret key stored in the second storage unit, used when the re-encryption key generation unit of the decryption rights delegation device generates a re-encryption key in this invention, corresponds to a combination of the decryption secret key and the secret key for re-encryption key generation in the above embodiment, and this secret key corresponds to the decryption secret key in the above proof.

### Second Embodiment

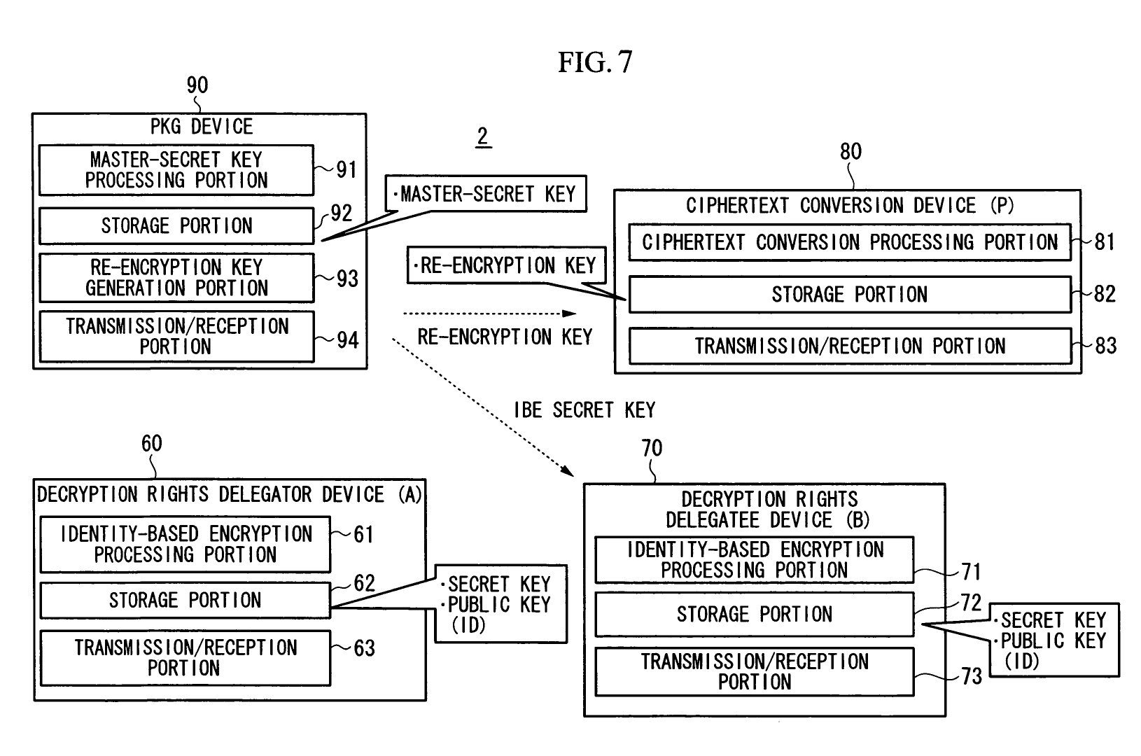

Below, a second embodiment of the invention is explained, referring to FIG. 7 through FIG. 9. In the second embodiment, a decryption rights delegation system (hereafter “delegation system”) between users who use an IBE system, in which a master-secret key held by a secret key generation device cannot be reconstructed even when there is collusion between the user of a decryption rights delegatee device and the user of the ciphertext conversion device, is explained.

FIG. 7 shows the configuration of the delegation system 2 of the second embodiment.

The dashed-line arrows between equipment in FIG. 7 indicate secure communication, that is, using circuits for which secrecy is secured and tampering can be prevented.

The delegation system 2 comprises a decryption rights delegator device 60 (hereafter also called “A”), a decryption rights delegates device 70 (hereafter also called “B”), a ciphertext conversion device 80 (hereafter also called “P”), and a PKG (secret key generation) device 90. The decryption rights delegator device 60 (A) and decryption rights delegatee device 70 (B) employ IBE system encryption.

In the PKG device 90, the storage portion 92 stores a master-secret key (mk) in advance. Here, the master-secret key of the second embodiment is defined as comprising, in addition to the master-secret key described in Reference 2 and in the first embodiment, information for use in generating a re-encryption key. From the master-secret key stored in the storage portion 92, the master-secret key processing portion 91 generates a secret key and auxiliary information corresponding thereto for devices performing IBE system encryption and decryption, such as the decryption rights delegator device 60 and the decryption rights delegates device 70. The re-encryption key generation device 93 generates a re-encryption key from the master-secret key and auxiliary information. The transmission/reception portion 94 transmits and receives information with the decryption rights delegator device 60, decryption rights delegatee device 70, and ciphertext conversion device 80.

In the decryption rights delegator device 60, the storage portion 62 stores an ID selected arbitrarily by the user of the decryption rights delegator device 60, that is, the IBE system public key, and the secret key generated and transmitted by the PKG device 90. The identity based encryption processing portion 61 executes an algorithm to perform encryption based on an identity based encryption system using the public key stored in the storage portion 62, and executes an algorithm to perform decryption using the secret key stored in the storage portion 62. The transmission/reception portion 63 transmits and receives information with the PKG device 90 and ciphertext conversion device 80.

In the decryption rights delegatee device 70, the storage portion 72 stores an ID selected arbitrarily by the user of the decryption rights delegatee device 70, that is, the IBE system public key, and the secret key generated and transmitted by the PKG device 90. The identity based encryption processing portion 71 executes an algorithm to perform IBE system encryption using the public key stored in the storage portion 72, and executes an algorithm to perform decryption using the secret key stored in the storage portion 72. The transmission/reception portion 73 transmits and receives information with the PKG device 90 and ciphertext conversion device 80.

In the ciphertext conversion device 80, the storage portion 82 stores the re-encryption key generated and transmitted by the PKG device 90. The ciphertext conversion processing portion 81 receives ciphertext transmitted from the decryption rights delegator device 10 using the transmission/reception portion 83, converts the received ciphertext using the re-encryption key stored in the storage portion 82, and transmits the converted ciphertext using the transmission/reception portion 83 to the decryption rights delegatee device 70. The transmission/reception portion 83 transmits and receives information with the PKG device 90, decryption rights delegator device 60, and decryption rights delegatee device 70.

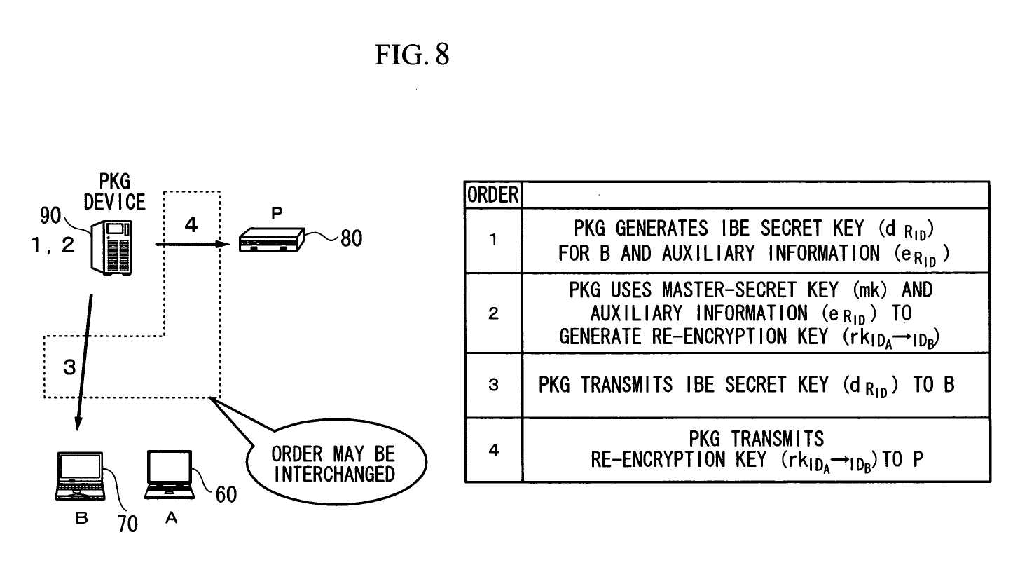

Next, processing to generate a secret key for the decryption rights delegatee device 70 and a re-encryption key for the ciphertext conversion device 80, performed by the PKG device 90 in the delegation system 1 of the second embodiment, is explained, referring to FIG. 8. First, the various symbols used in the explanation below are defined as follows.

### DEFINITIONS

[symbol] : Set of natural numbers other than 0 up to complex number p exclusive (hereafter denoted by Zₚ*),

[symbol] : Groups of prime order p which can define a bilinear map (hereafter denoted by G and G₁),

ê: [symbol] : A bilinear map,

ID: The ID of a user (rights delegates) using identity based encryption. The bit size necessary for binary representation of ID is taken to be 1,

[symbol] : When ID is represented in binary notation, the set of indexes corresponding to digits for which the bit is “1”. For example, if ID=100110, then ={2,3,6}, and if ID=001001, then ={1,4}.

[symbol]

[symbol]

As premises of the processing by the PKG device 90 to generate the secret key of the decryption rights delegatee device 70 and the re-encryption key of the ciphertext conversion device 80, as initialization processing the PKG device 90 uses a security parameter k, randomly selects a generator gεG in the group G, and selects random elements g₂, h₁, h₂εG in the group G. Then, random elements α, ωεZₚ* in Zₚ* are selected, and the master-secret key mk and public parameters parms are stored in the storage portion 92, as indicated in equation (5) below, wherein parms are public parameters which can be accessed by a third party:

$$\begin{matrix}mk = ( {g}_{2}^{α} , w ) \\ {g}_{1} = {g}^{α} \\ {\tilde{H}}_{1} = {h}_{2}^{w} , {\tilde{H}}_{2} = {h}_{2}^{{w}^{2}} , … , {\tilde{H}}_{l} = {h}_{2}^{{w}^{l}} \\ parms = ( g , {g}_{1} , {g}_{2} , {h}_{1} , {\tilde{H}}_{1} , … , {\tilde{H}}_{l} )\end{matrix} \} \qquad ( 5 )$$

Under processing under the above premises, the processing to generate the secret key for the decryption rights delegatee device 70 and the re-encryption key for the ciphertext conversion device 80 is performed as follows.

First, the master-secret key processing portion 91 of the PKG device 90 generates auxiliary information (e_{R}_{_{ID}}) and an IBE system secret key (d_{R}_{_{ID}}) for decryption rights delegation, for use by the decryption rights delegatee device 70. Specifically, the master-secret key mk=(g₂^{α},ω), an ID (corresponding to ID_{A}, described below) which is the public key selected by the user of the decryption rights delegator device 60, and the public parameters parms are input, and random elements u,sεZₚ* in Zₚ* are selected, and the identity based encryption secret key (d_{R}_{_{ID}}) for decryption rights delegation used by the decryption rights delegates device 70 and auxiliary information (e_{R}_{_{ID}}) are computed using the following equation (6) (step (1)):

(d_{R}_{_{ID}},e_{R}_{_{ID}})=((d₀,d₁),e_{R}_{_{ID}})=((g₂^{a}(g₁^{ID}h₁)^{u}h₂^{s},g^{u}),g^{s}) (6)

Next, the re-encryption key generation portion 93 of the PKG device 90 uses the auxiliary information ((e_{R}_{_{ID}}) determined according to the master-secret key (mk) and equation (6) to generate the re-encryption key (rk_{ID}_{_{A}}_{→ID}_{_{B}}). Specifically, the master-secret key mk=(g₂^{α},ω), ID_{A}, which is a public key selected by the user of the decryption rights delegator device 60, auxiliary information (ε_{R}_{_{ID}}=g^{s}) generated according to equation (6) corresponding to the secret key of the decryption rights delegatee device 70 by the master-secret key processing portion 91, and the public parameters parms are input, and the re-encryption key (rk_{ID}_{_{A}}_{→ID}_{_{B}}) is generated by performing computations according to equation (7) (step (2)):

$${rk}_{{ID}_{A} \to {ID}_{B}} = {g}^{s / {\sum }_{t ∈ {I}_{ID}} {log}_{{h}_{2}} {\tilde{H}}_{t}} \qquad ( 7 )$$

wherein ID_{B} is a public key selected by the user of the decryption rights delegated device 70.

The master-secret key processing portion 91 of the PKG device 90 transmits the generated IBE system secret key (d_{R}_{_{ID}}) using the transmission/reception portion 94 to the decryption rights delegatee device 70 via a secure communication path. The decryption rights delegatee device 70 stores the received secret key (d_{R}_{_{ID}}) in the storage portion 72 (step (3)). The re-encryption key generation portion 93 of the PKG device 90 transmits the generated re-encryption key (rk_{ID}_{_{A}}_{→ID}_{_{B}}) using the transmission/reception portion 94 to the ciphertext conversion device 80. The ciphertext conversion device 80 records the re-encryption key received by the transmission/reception portion 83 in the storage portion 82 (step (4)).

As shown in FIG. 8, the order of processing of step (3) and step (4) may be reversed.

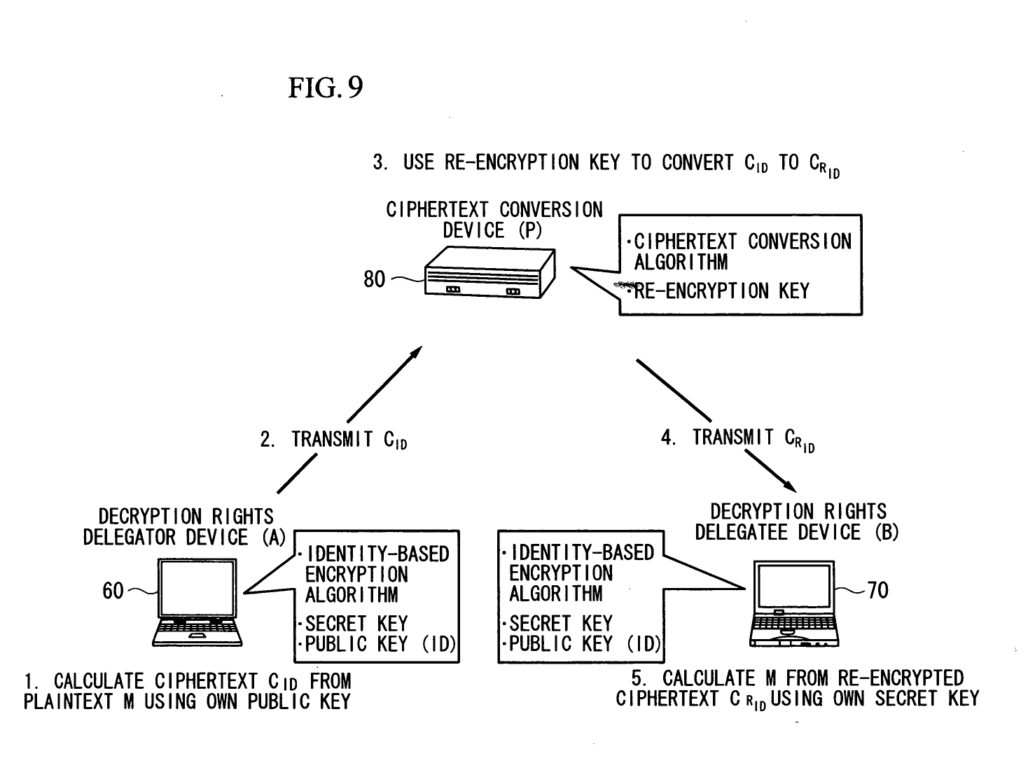

Next, processing to encrypt, convert, and decrypt plaintext, using the public key, re-encryption key, and secret key generated as described above, is explained referring to FIG. 9.

First, taking as input the public key (ID_{A}εG), plaintext (MεG₁), and the public parameters parms, a random element rεZₚ* in Zₚ* is selected, and the following equation (8) is used to generate the ciphertext C_{ID} (step (1)):

C_{ID}=(C₁, C₂,C₃,C₄)=(π_{tεI}_{_{ID}}\tilde{H}ₜ,g^{r},(g₁^{ID}h₁)^{r},M·ê(g₁,g₂)^{r})ε [symbol] × [symbol] (8)

When the ciphertext C_{ID} is generated, the identity based encryption portion 61 transmits the generated ciphertext C_{ID} to the ciphertext conversion device 80 using the transmission/reception portion 63 (step (2)). The ciphertext conversion processing portion 81 of the ciphertext conversion device 80 takes as input the ciphertext C_{ID}=(C₁,C₂,C₃,C₄) received via the transmission/reception portion 83, the public key ID_{A} of the decryption rights delegator device 60 which is made public, and the re-encryption key (rk_{ID}_{_{A}}_{→ID}_{_{B}}) stored in the storage portion 82, and converts C_{ID} according to the following equation (9) to generate the converted ciphertext C_{R}_{_{ID}} (step (3)):

C_{R}_{_{ID}}=(C′₁,C′₂,C′₃)=(C₂,C₃, C₄·ê(C₁,g^{s/Σ}_{tεZ ID} ^{log}_{h2 \tilde{H}})ε [symbol] × [symbol] (9)

The ciphertext conversion processing portion 81 which generates the converted ciphertext C_{R}_{_{ID}} transmits the converted ciphertext C_{R}_{_{ID}} to the decryption rights delegatee device 70 via the transmission/reception portion 83 (step (4)). The identity based encryption processing portion 71 of the decryption rights delegatee device 70, upon receiving the converted ciphertext C_{R}_{_{ID}} via the transmission/reception portion 73, takes as input the received C_{R}_{_{ID}}=(C₁′,C₂′,C₃′), the secret key (d_{R}_{_{ID}}=(d₀,d₁)) stored in the storage portion 72, and the public parameters parms, and reproduces the plaintext M according to equation (10) (step (5)):

M=C′₃·ê(d₁,C′₂)/ê(d₀,C′₁) (10)

In the above configuration, the re-encryption key used by the ciphertext conversion device 80 and the secret key for decryption rights delegation used by the decryption rights delegatee device 70 are not generated by dividing a master-secret key. Hence even when there is collusion between the user of the ciphertext conversion device 80 and the user of the decryption rights delegatee device 70, the master-secret key of the PKG device 90 cannot be reproduced, and the security of the IBE system delegation system 2 can be ensured.

The security of the delegation system 2 realized by means of the above-described configuration is proven as described below.

(Definition 1)

For randomly chosen integers

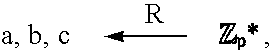

a random generator

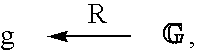

and an element

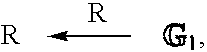

we define advantage of an algorithm [symbol] in solving the decision Bilinear Diffie-Hellman (dBDH) problem as follows:

[symbol]

=|Pr[ [symbol] (g,g^{a},g^{b},g^{c},ê(g,g)=0]−Pr[ [symbol] (g,g^{a},g^{b},g^{c},R)=0]|

where the probability is over the random choice of generator gε [symbol] , the randomly chosen integers a, b, c, the random choice of Rε [symbol] , and the random bits used by A. We say that the (k, t, ε)-dBDH assumption holds in [symbol] if no t-time algorithm has advantage at least ε in solving the dBDH problem in [symbol] under a security parameter k.

(Security Notion)

(Chosen Plaintext Security)

We model chosen plaintext security for an IBE proxy re-encryption system as a game between an adversary [symbol] and a challenger C. In this game, the adversary is allowed to adaptively choose the secret key queries and re-encryption key queries. Since the adversary obviously wins the game if it obtains both the delegatee's second level secret key and the corresponding re-encryption key involving the target identity, she is not allowed to ask such query. She is also not allowed to ask for the first level secret key for the target identity. More precisely, IND-ID-CPA security is defined as follows:

<Setup>
The challenger C generates (parms,mk). C gives parms to [symbol] , keeping mk to itself. C maintains a table containing a list of previously queried identities and which queries were issued for those identities.

<Phase 1>
Given parms, [symbol] adaptively queries the challenger for either an IBE secret key or a re-encryption key. After some queries, [symbol] selects a target identity ID* and two equal length plaintexts M₀, M₁ε [symbol] . When [symbol] queries the challenger, C responds as follows:
   First level secret key queries: Suppose that [symbol] queries the challenger at a point IDᵢ. If IDᵢ=ID* then C rejects the query. Otherwise, C generates (d_{ID}_{ᵢ}·e_{ID}_{ᵢ}) for IDᵢ. C returns the secret key d_{ID}_{ᵢ} to [symbol] with auxiliary information e_{ID}_{ᵢ}.
   Second level secret key queries: Suppose that [symbol] queries the challenger at a point IDᵢ. C generates [symbol] . C returns the secret key [symbol] to A with auxiliary information [symbol] .
   Re-encryption key queries: Suppose that [symbol] queries the challenger at a point ( [symbol] , IDᵢ, IDⱼ). If C previously issued [symbol] and IDᵢ=ID* then C rejects the query. Otherwise, C generates [symbol] and returns it to [symbol] .

<Challenge>
Given (M₀, M₁, ID*), C selects

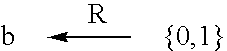

and computes a ciphertext C_{ID}_{_{b}} of the selected message M_{b}. C returns C_{ID}_{_{b}} to [symbol] .

<Phase 2>
[symbol] A continues to issue queries as in Phase 1, and C responds as before.

<Guess>
Finally, [symbol] outputs a guess \tilde{b}ε{0, 1}.
The adversary [symbol] wins if \tilde{b}=b. An IBE proxy re-encryption system is secure in the sense of IND-ID-CPA if |Pr[\tilde{b}=b]−½| is negligible.

(Definition 3)

Let [symbol] be an adversary against the IBE proxy re-encryption system. Define the IND-ID-CPA advantage of [symbol] as follows:

Adv_{ibep}^{idcpa}( [symbol] )=2(Pr[\tilde{b}=b]−½)

We say that the an IBE proxy re-encryption system is (k, t, q, ε) adaptive chosen plaintext secure if for any t time IND-ID-CPA adversary [symbol] that makes at most q chosen queries under a security parameter k we have that Adv_{ibep}^{idcpa}( [symbol] )<ε. As shorthand, we say that an IBE proxy re-encryption system is (k, t, q, ε) IND-IDCPA secure.

We define the selective adversary who is identical to the above adversary except that it discloses to the challenger the target identity before the setup. We denote the selective IND-ID-CPA by IND-sID-CPA and the advantage of the selective adversary by Adv_{ibep}^{sidcpa}. The definition is as same as that of Definition 3.

(Security Analysis)

(Theorem 2)

Suppose that the (k, t, ε)-dBDH assumption holds. Then the IBE proxy re-encryption system is (k, t′, q, ε) IND-sID-CPA secure for any q, k, and t′<t−θ(τq) where τ is the maximum time for an exponentiation in [symbol] .

(Proof)

Let [symbol] be an adversary in the IND-sID-CPA sense. We construct an adversary B which solves the dBDH problem in [symbol] by utilizing [symbol] . Providing that [symbol] is given an input (g, Γ₁, Γ₂, Γ₃, X)=(g, g^{a}, g^{b}, g^{c}, X), where X=ê(g,g)^{abc} or

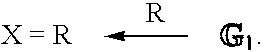

We describe how [symbol] works in the following:

<Initialization>
[symbol] maintains a table containing a list of previously queried identities and which queries were issued for those identities. The selective identity game begins with [symbol] first outputting a target identity ID*.

<Setup>
To generate the system parameters, algorithm [symbol] picks

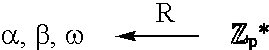

and sets g₁=Γ₁, g₂=Γ₂, h₁=g₁^{-ID*}g^{α}, h₂=g^{β}. [symbol] computes

$${\tilde{H}}_{1} = {h}_{2}^{ω} , … , {\tilde{H}}_{1} = {h}_{2}^{{w}^{l}}$$

and gives [symbol] the system parameters
Note that the corresponding PKG's master-secret key, which is unknown to [symbol] , is g₂^{a}=g^{ab}ε

[symbol]

<Phase 1>
Given parms, [symbol] asks some queries to the challenger. [symbol] chooses two equal length plaintexts M₀, M₁ε [symbol] . When [symbol] queries the challenger, [symbol] works as follows:
   First level secret key queries: Suppose that [symbol] queries the challenger at a point IDᵢ. If IDᵢ=ID* then [symbol] rejects the query. Otherwise, [symbol] selects

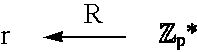

and sets

$$( {d}_{{ID}_{i}} , {e}_{{ID}_{i}} ) = ( {{g}_{2}^{\frac{- α}{{ID}_{i} - {ID}^{*}}} ( {g}_{1}^{{ID}_{i} - {ID}^{*}} {g}^{α} )}^{r} ; {g}_{2}^{\frac{- 1}{{ID}_{i} - {ID}^{*}}} {g}^{r} ) .$$

[symbol]

returns (d_{ID}_{ᵢ},e_{ID}_{ᵢ}) to [symbol] .
Second level secret key queries: Suppose that [symbol] queries the challenger at a point IDᵢ. [symbol] selects

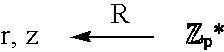

and sets

$$( {d}_{{R}_{{ID}_{i}}} , {e}_{{R}_{{ID}_{i}}} ) = ( ( {{g}_{2}^{\frac{- α}{{ID}_{i} - {ID}^{*}}} ( {g}_{1}^{{ID}_{i} - {ID}^{*}} {g}^{α} )}^{r} {( {g}^{β} )}^{z} , {g}_{2}^{\frac{- 1}{{ID}_{i} - {ID}^{*}}} {g}^{r} ) , {g}^{z} ) .$$

[symbol]

returns [symbol] to [symbol] .
Re-encryption key queries: Suppose that [symbol] queries the challenger at a point ( [symbol] IDᵢ, IDⱼ) where [symbol] =g^{z}. If [symbol] previously issued [symbol] and IDᵢ=ID* then [symbol] rejects the query. Otherwise, [symbol] sets

$${rk}_{{ID}_{i} \to {ID}_{j}} = {g}^{z / {\sum }_{t ∈ {I}_{{ID}_{i}} {log}_{{h}_{2}} {\tilde{H}}_{t}}}$$

and returns the result to [symbol] .

<Challenge>
Given (M₀, M₁), [symbol] selects

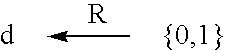

and sets

$${C}_{{ID}_{d}} = ( {Γ}_{3}^{β {\sum }_{t ∈ {ℐ}_{{ID}^{*}}} {log}_{{h}_{2}} {\tilde{H}}_{t}} , {Γ}_{3} , {Γ}_{3}^{α} , {M}_{d} \cdot X )$$

[symbol] returns C_{ID}_{_{d}} to [symbol] . Notice that if x=ê(g,g)^{abc}=ê(g₁,g₂)^{c} then C_{ID}_{_{d}} is a valid encryption of M_{d}. On the other hand, if X is uniform and independent in [symbol] then C_{ID}_{_{d}} is independent of b in the adversary's view.

<Phase 2>
[symbol] continues to issue queries as in Phase 1. [symbol] responds as before.

<Solve>
Finally, [symbol] outputs a guess d′ε{0, 1}. [symbol] concludes its own game by outputting a guess as follows: If d′=d then [symbol] outputs 1 meaning X=ê(g,g)^{abc}. Otherwise, it outputs 0 meaning X=R.

We claim that [symbol] generates valid first level secret keys and the corresponding auxiliary information for IDᵢ. To see this, let

$${\tilde{u}}_{i} = {r}_{i} - \frac{b}{{ID}_{i} - {ID}^{*}}$$

and we consider the first level secret key. Then we have that

$$\begin{matrix}( {d}_{{ID}_{i}} , {e}_{{ID}_{i}} ) = ( {{g}_{2}^{\frac{- α}{{ID}_{i} - {ID}^{*}}} ( {g}_{1}^{{ID}_{i} - {ID}^{*}} {g}^{α} )}^{{r}_{i}} , {g}_{2}^{\frac{- 1}{{ID}_{i} - {ID}^{*}}} {g}^{{r}_{i}} ) \\ = ( \frac{{{g}_{2}^{α} ( {g}_{1}^{{ID}_{i} - {ID}^{*}} {g}^{α} )}^{{r}_{i}}}{{( {g}_{1}^{{ID}_{i} - {ID}^{*}} {g}^{α} )}^{\frac{b}{{ID}_{i} - {ID}^{*}}}} , {g}^{{r}_{i} - \frac{b}{{ID}_{i} - {ID}^{*}}} ) \\ = ( {{g}_{2}^{α} ( {g}_{1}^{{ID}_{i}} {h}_{1} )}^{{r}_{i} - \frac{b}{{ID}_{i} - {ID}^{*}}} , {g}^{{r}_{i} - \frac{b}{{ID}_{i} - {ID}^{*}}} ) \\ = ( {{g}_{2}^{α} ( {g}_{1}^{{ID}_{i}} {h}_{1} )}^{{\tilde{u}}_{i}} , {g}^{{\tilde{u}}_{i}} )\end{matrix}$$

It is obvious that [symbol] can simulate the second level secret keys. Since [symbol] can perfectly simulate re-encryption keys and secret keys, we conclude the theorem 2.

The delegation system 1 and delegation system 2 of the above first and second embodiments are each a single ciphertext decryption rights delegation system which, for ciphertext transmitted from a decryption rights delegator device, enables decryption by a decryption rights delegatee device through conversion of the ciphertext by a ciphertext conversion device using a re-encryption key. Such a ciphertext decryption rights deletion system is divided into a re-encryption key generation phase and a phase in which content sharing is performed; in the re-encryption key generation phase in the configuration of the above first and second embodiments, a master-secret key held by an IBE system secret key generator is used to generate an IBE system secret key, and to generate auxiliary information related thereto, and based on this auxiliary information, the re-encryption key is generated. On the other hand, in the content sharing phase, ciphertext generated by the decryption rights delegator device is converted into IBE-system ciphertext in the ciphertext conversion device, and the converted ciphertext is decrypted by the decryption rights delegatee device using the IBE system secret key.

The above-described first embodiment is characterized in comprising a PKG device, which generates an IBE system secret key using a master-secret key; a decryption rights delegator device, which performs PKE system encryption; a ciphertext conversion device, which converts PKE system ciphertext transmitted from the decryption rights delegator device into IBE system ciphertext so as to enable decryption by a decryption rights delegatee device; and, a decryption rights delegatee device, which performs IBE system decryption.

The above-described second embodiment is characterized in comprising a PKG device, which generates an IBE system secret key and a re-encryption key using a master-secret key; a decryption rights delegator device, which performs IBE system encryption; a ciphertext conversion device, which converts IBE system ciphertext transmitted from the decryption rights delegator device into another IBE system ciphertext so as to enable decryption by a decryption rights delegatee device; and, a decryption rights delegatee device, which performs IBE system decryption.

In the above, preferred embodiments of the invention have been explained, but the invention is not limited to these embodiments. Various additions, omissions, substitutions, and other modifications can be made, without deviating from the gist of the invention. The invention is not limited by the above explanations, but is limited only by the attached Scope of Claims.

The decryption rights delegator device 10, decryption rights delegatee device 20, ciphertext conversion device 30, and PKG device 40 of the above-described first embodiment, as well as the decryption rights delegator device 60, decryption rights delegates device 70, ciphertext conversion device 80, and PKG device 90 of the above-described second embodiment, each have an internal computer system. The processing in each of the above-described devices is performed by having computers read and execute programs stored on computer-readable recording media. Here “computer-readable recording media” may be magnetic disks, magneto-optical discs, CD-ROMs, DVD-ROMs, semiconductor memory, or other media. Computer programs may also be distributed to computers through communication circuits, so that a computer receiving this distribution executes the program.

What is claimed is:

1. A decryption rights delegation system, in which ciphertext decryption rights delegation is performed between a decryption rights delegator device and a decryption rights delegates device, and comprising a ciphertext conversion device which performs conversion using a re-encryption key such that ciphertext transmitted from said decryption rights delegator device can be decrypted by said decryption rights delegatee device, comprising:
a master-secret key processing unit which generates secret keys and auxiliary information for an identity based encryption system from a master-secret key of said identity based encryption system; and
a re-encryption key generation unit which generates a re-encryption key for conversion of ciphertext, encrypted by said decryption rights delegator device, based on said auxiliary information generated by said master-secret key processing unit, so that said decryption rights delegatee device can perform decryption using said identity based encryption system secret key.

2. A decryption rights delegation system, comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, wherein
said secret key generation device comprises:
a first storage unit which stores said master-secret key;
a master-secret key processing unit which generates, based on the master-secret key stored by said first storage unit and on an identity based encryption system public key selected arbitrarily by said decryption rights delegatee device, auxiliary information and an identity based encryption system secret key used in decryption by said decryption rights delegatee device and corresponding to the identity based encryption public key;
a secret key transmission unit which transmits said identity based encryption system secret key generated by said master-secret key processing unit to said decryption rights delegatee device; and
an auxiliary information transmission unit which transmits said auxiliary information generated by said master-secret key processing unit to said decryption rights delegator device; and wherein
said decryption rights delegator device comprises:
a second storage unit which stores said public key encryption system public key and secret key;
an auxiliary information reception unit which receives said auxiliary information from said secret key generation device;
a re-encryption key generation unit which generates, based on the secret key stored in said second storage unit and auxiliary information received by said auxiliary information reception unit, a re-encryption key used by said ciphertext conversion device when converting ciphertext; and
a re-encryption key transmission unit which transmits the re-encryption key generated by said re-encryption key generation unit to said ciphertext conversion device.

3. The decryption rights delegation system according to claim 2, wherein said decryption rights delegator device comprises:
a public key encryption processing unit which uses a public key stored by said second storage unit to encrypt plaintext and generates ciphertext; and
a ciphertext transmission unit which transmits the ciphertext generated by said public key encryption processing unit to said ciphertext conversion device; wherein
said ciphertext conversion device comprises:
a re-encryption key reception unit which receives a re-encryption key from said decryption rights delegator device;
a ciphertext reception unit which receives the ciphertext from said decryption rights delegator device;
a ciphertext conversion processing unit which converts the ciphertext received by said ciphertext reception unit based on a re-encryption key received by said re-encryption key reception unit; and
a converted ciphertext transmission unit which transmits the ciphertext converted by said ciphertext conversion processing unit to said decryption rights delegatee device; and wherein
said decryption rights delegatee device comprises:
a secret key reception unit which receives a secret key for said identity based encryption system transmitted from said secret key generation device;
a converted ciphertext reception unit which receives converted ciphertext from said ciphertext conversion device; and
an identity based encryption processing unit which decrypts ciphertext received by said converted ciphertext reception unit based on said identity based encryption system secret key received by said secret key reception unit.

4. A secret key generation device, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, comprising:
a storage unit which stores said master-secret key;
a master-secret key processing unit which generates identity based encryption system secret keys and auxiliary information for use in decryption by said decryption rights delegatee device, based on the master-secret key stored by said storage unit and an identity based encryption system public key chosen arbitrarily by said decryption rights delegatee device and corresponding to the identity based encryption public key; and
a transmission unit which transmits the identity based encryption system secret key generated by said master-secret key processing unit to said decryption rights delegatee device, to cause generation by said decryption rights delegator device of a re-encryption key for use by said ciphertext conversion device.

5. A decryption rights delegator device, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, comprising:
a storage unit which stores the public key of said public key encryption system and a secret key;
an auxiliary information reception unit which receives from said secret key generation device both said master-secret key and auxiliary information generated based on an identity based encryption system public key selected arbitrarily by said decryption rights delegates device;
a re-encryption key generation unit which generates a re-encryption key based on the secret key stored by said storage unit and on auxiliary information received by said auxiliary information reception unit for use when said ciphertext conversion device converts ciphertext; and
a re-encryption key transmission unit which transmits the re-encryption key generated by said re-encryption key generation unit to said ciphertext conversion device.

6. A decryption rights delegation system, comprising a decryption rights delegator device which performs encryption using an identity based encryption system, a decryption rights delegates device which performs encryption using an identity based encryption system, a secret key generation device which generates a secret key used in an identity based encryption system based on a master-secret key, and a ciphertext conversion device which converts ciphertext encrypted and transmitted by said decryption rights delegator device such that said decryption rights delegatee device can decrypt the ciphertext, wherein said secret key generation device comprises:
a storage unit which stores said master-secret key;
a master-secret key processing unit which generates, based on the master-secret key stored by said storage unit and an identity based encryption system public key selected arbitrarily by said decryption rights delegator device, auxiliary information and an identity based encryption system secret key used in decryption by said decryption rights delegatee device;
a re-encryption key generation unit which generates a re-encryption key based on the master-secret key stored by said storage unit and on said auxiliary information;
a secret key transmission unit which transmits to said decryption rights delegatee device of an identity based encryption system secret key generated by said master-secret key processing unit; and
a re-encryption key transmission unit which transmits to said ciphertext conversion device of the re-encryption key generated by said re-encryption key generation unit.

7. The decryption rights delegation system according to claim 6, wherein said decryption rights delegator device comprises:
an identity based encryption processing unit which encrypts plaintext to generate ciphertext using an arbitrarily selected identity based encryption public key; and
a ciphertext transmission unit which transmits said ciphertext generated by said identity based encryption processing unit to said ciphertext conversion device; wherein
said ciphertext conversion device comprises:
a re-encryption key reception unit which receives a re-encryption key from said secret key generation device;
a ciphertext reception unit which receives ciphertext from said decryption rights delegator device;
a ciphertext conversion processing unit which converts ciphertext received by said ciphertext reception unit based on the re-encryption key received by said re-encryption key reception unit; and
a converted ciphertext transmission unit which transmits ciphertext converted by said ciphertext conversion processing unit to said decryption rights delegatee device; and wherein
said decryption rights delegatee device comprises:
a secret key reception unit which receives said identity based encryption secret key from said secret key generation device;
a converted ciphertext reception unit which receives said ciphertext from said ciphertext conversion device; and
an identity based encryption processing unit which decrypts ciphertext received by said converted ciphertext reception unit based on said identity based encryption secret key received by said secret key reception unit.

8. A secret key generation device, in a decryption rights delegation system comprising a decryption rights delegator device which performs encryption using an identity based encryption system, a decryption rights delegates device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, comprising:
a storage unit which stores said master-secret key;
a master-secret key processing unit which generates identity based encryption system secret keys and auxiliary information for use in decryption by said decryption rights delegatee device, based on the master-secret key stored by said storage unit and an identity based encryption system public key chosen arbitrarily by said decryption rights delegator device;
a re-encryption key generation unit which generates a re-encryption key based on the master-secret key stored by said storage unit and on said auxiliary information;
a secret key transmission unit which transmits to said decryption rights delegatee device an identity based encryption system secret key generated by said master-secret key processing unit; and
a re-encryption key transmission unit which transmits to said ciphertext conversion device a re-encryption key generated by said re-encryption key generation unit.

9. Computer-readable recording media, on which is recorded a ciphertext decryption rights delegation program, which causes a computer, in a decryption rights delegation system in which ciphertext decryption rights delegation is performed between a decryption rights delegator device and a decryption rights delegatee device, comprising a ciphertext conversion device which uses a re-encryption key to convert ciphertext transmitted from said decryption rights delegator device so as to enable decryption by said decryption rights delegatee device, to execute the steps of:
generating from a master-secret key of an identity based encryption system a secret key for said identity based encryption system and auxiliary information; and
generating a re-encryption key to convert ciphertext encrypted by said decryption rights delegator device based on the generated auxiliary information, so as to enable said decryption rights delegatee device to perform decryption using said identity based encryption system secret key.

10. Computer-readable recording media, on which is recorded a ciphertext decryption rights delegation program, which causes a computer, in a decryption rights delegation system comprising a decryption rights delegator device which performs encryption using a standard public key encryption method, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, to execute, through said secret key generation device, the steps of:
storing said master-secret key in a first storage unit;
generating, based on the master-secret key stored in said first storage unit and an identity based encryption system public key selected arbitrarily by said decryption rights delegatee device, auxiliary information and an identity based encryption system secret key corresponding to the identity based encryption public key and to be used when said decryption rights delegatee device performs decryption;
transmitting the generated identity based encryption system secret key to said decryption rights delegatee device; and,
transmitting said generated auxiliary information to said decryption rights delegator device;
and to execute, through said decryption rights delegator device the steps of:
storing the public key encryption system public key and secret key in a second storage unit;
receiving said auxiliary information from said secret key generation device;
generating a re-encryption key to be used when said ciphertext conversion device converts ciphertext, based on the secret key stored by said second storage unit and on the received auxiliary information; and
transmitting the generated re-encryption key to said ciphertext conversion device.

11. Computer-readable recording media, on which is recorded a secret key generation program, which causes the computer of a secret key generation device, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, to execute the steps of:
causing storage of said master-secret key in a storage unit;
generating, based on a master-secret key stored in said storage unit and on an identity based encryption system public key selected arbitrarily by said decryption rights delegatee device, auxiliary information and an identity based encryption secret key corresponding to the identity based encryption public key, for use when said decryption rights delegatee device performs decryption; and
transmitting the generated identity based encryption system secret key to said decryption rights delegatee device, transmitting said generated auxiliary information to said decryption rights delegator device, and causing said decryption rights delegator device to generate a re-encryption key for use by said ciphertext conversion device.

12. Computer-readable recording media, on which is recorded a decryption rights delegation program, which causes the computer of a decryption rights delegator device, in a decryption rights delegation system comprising a decryption rights delegator device which performs encryption using a standard public key encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, to execute the steps of:
causing storage of a public key of said public key encryption system and a secret key in a storage unit;
receiving, from said secret key generation device, auxiliary information generated based on said master-secret key and on an identity based encryption system public key arbitrarily selected by said decryption rights delegatee device;
generating a re-encryption key based on the secret key stored in said storage unit and on the received auxiliary information, for use when said ciphertext conversion device converts ciphertext; and
transmitting the generated re-encryption key to said ciphertext conversion device.

13. Computer-readable recording media, on which is recorded a decryption rights delegation program, which causes the computer of a decryption rights delegator device, in a decryption rights delegation system comprising a decryption rights delegator device which performs encryption using an identity based encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, to execute, through said secret key generation device, the steps of:
causing storage of said master-secret key in a storage unit;
generating, based on the master-secret key stored in said storage unit and on an identity based encryption system public key arbitrarily selected by said decryption rights delegator device, auxiliary information and an identity based encryption system secret key to be used by said decryption rights delegatee device when performing decryption;
generating a re-encryption key based on the master-secret key stored in said storage unit and on said auxiliary information;
transmitting the generated identity based encryption system secret key to said decryption rights delegatee device; and
transmitting the generated re-encryption key to said ciphertext conversion device.

14. Computer-readable recording media, on which is recorded a secret key generation program, which causes the computer of a secret key generation device, in a decryption rights delegation system comprising a decryption rights delegator device which performs encryption using an identity based encryption system, a decryption rights delegatee device which performs encryption using an identity based encryption system, a secret key generation device which generates secret keys used in an identity based encryption system based on a master-secret key, and a ciphertext conversion device which converts ciphertext, encrypted and transmitted by said decryption rights delegator device, so as to enable decryption of said ciphertext by said decryption rights delegatee device, to execute the steps of:
causing storage of said master-secret key in a storage unit;
generating, based on a master-secret key stored in said storage unit and on an identity based encryption system public key selected arbitrarily by said decryption rights delegator device, auxiliary information and an identity based encryption secret key for use when said decryption rights delegatee device performs decryption;
generating a re-encryption key based on the master-secret key stored in said storage unit and on said auxiliary information;
transmitting the generated identity based encryption system secret key to said decryption rights delegatee device; and
transmitting the generated re-encryption key to said ciphertext conversion device.
